(19) United States
(12) Patent Application Publication
(10) Pub. No.: US 2008/0077494 A1
(43) Pub. Date: Mar. 27, 2008

(54) Advertisement Selection For Peer-To-Peer Collaboration

(76) Inventors: Cuneyt Ozveren, Saratoga, CA (US); Ulas Kirazci, Sunnyvale, CA (US)

Correspondence Address: HOLMAN IP LAW, 175 S Main Street, Suite #850, Salt Lake City, UT, 84111, US

(21) Appl. No.: 11/859,496

(22) Filed: Sep. 21, 2007

Related U.S. Application Data
(60) Provisional application No. 60/846,788, filed on Sep. 22, 2006.

(51) Int. Cl. G06Q 30/00

(52) U.S. Cl. 705/14

(57) ABSTRACT

A system and method for advertisement selection. The system includes a client and an advertisement selection application. The client is capable of accessing content objects over the internet. The advertisement selection application is coupled to the client and configured to maintain at least a partial copy of advertisements. The advertisement selection application is also configured to classify the advertisements and to generate an object vector for each advertisement. The advertisement selection application is also configured to update a user interest profile in response to positive and negative feedback, and to display advertisements according to the user interest profile.

### CROSS-REFERENCE TO RELATED APPLICATIONS

This application claims the benefit of U.S. Provisional Application No. 60/846,788, entitled “Peer-to-Peer Collaboration” and filed on Sep. 22, 2006, which is incorporated herein in its entirety.

### BACKGROUND

This invention relates to the field of online services and, in particular, to peer-to-peer collaboration and sharing interests.

### SUMMARY

Embodiments of a system are described. In one embodiment, the system is a system for advertisement selection. An embodiment of the system includes a client and an advertisement selection application. The client is capable of accessing content objects over the internet. The advertisement selection application is coupled to the client and configured to maintain at least a partial copy of advertisements. The advertisement selection application is also configured to classify the advertisements and to generate an object vector for each advertisement. The advertisement selection application is also configured to update a user interest profile in response to positive and negative feedback, and to display advertisements according to the user interest profile. Other embodiments of the system are also described.

Embodiments of a computer program product are also described. In one embodiment, the computer program product includes a computer useable storage medium to store a computer readable program that, when executed on a computer, causes the computer to perform one or more operations. In one embodiment, the operations include an operation to access content objects over the internet, an operation to maintain at least a partial copy of advertisements, an operation to classify the advertisements and generate an object vector for each advertisement, an operation to update a user interest profile in response to positive and negative feedback, and an operation to display advertisements according to the user interest profile. Other embodiments of the computer program product are also described.

Embodiments of a method are also described. In one embodiment, the method is a method for advertisement selection. An embodiment of the method includes accessing content objects over the internet, maintaining at least a partial copy of advertisements, classifying the advertisements, generating an object vector for each advertisement, updating a user interest profile in response to positive and negative feedback, and displaying advertisements according to the user interest profile. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

Embodiments of the present invention are illustrated by way of example, and not by way of limitation, in the figures of the accompanying drawings. Throughout the description, similar reference numbers may be used to identify similar elements.

FIG. 1 illustrates one embodiment of an online system.

FIG. 2 illustrates one embodiment of a client of the online system of FIG. 1.

FIG. 3 illustrates one embodiment of a web browser with a user interface for the online system of FIG. 1.

FIG. 4 illustrates another embodiment of the web browser and user interface of FIG. 2.

FIG. 5 illustrates another embodiment of the web browser and user interface of FIG. 2.

FIG. 6 illustrates another embodiment of the web browser and user interface of FIG. 2.

FIG. 7 illustrates another embodiment of the web browser and user interface of FIG. 2.

FIG. 8 illustrates a schematic flow chart diagram of one embodiment of a content search algorithm.

FIG. 9 illustrates a schematic flow chart diagram of another embodiment of a content search algorithm for searching a static domain.

FIG. 10 illustrates a schematic flow chart diagram of another embodiment of a content search algorithm for searching a dynamic domain using really simple syndication (RSS) feeds.

FIGS. 11-23 illustrate embodiments of hierarchical classification algorithms that may be implemented in the online system of FIG. 1.

FIG. 24 illustrates another embodiment of the client of FIG. 2.

### DETAILED DESCRIPTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the spirit and scope of this description and the appended claims.

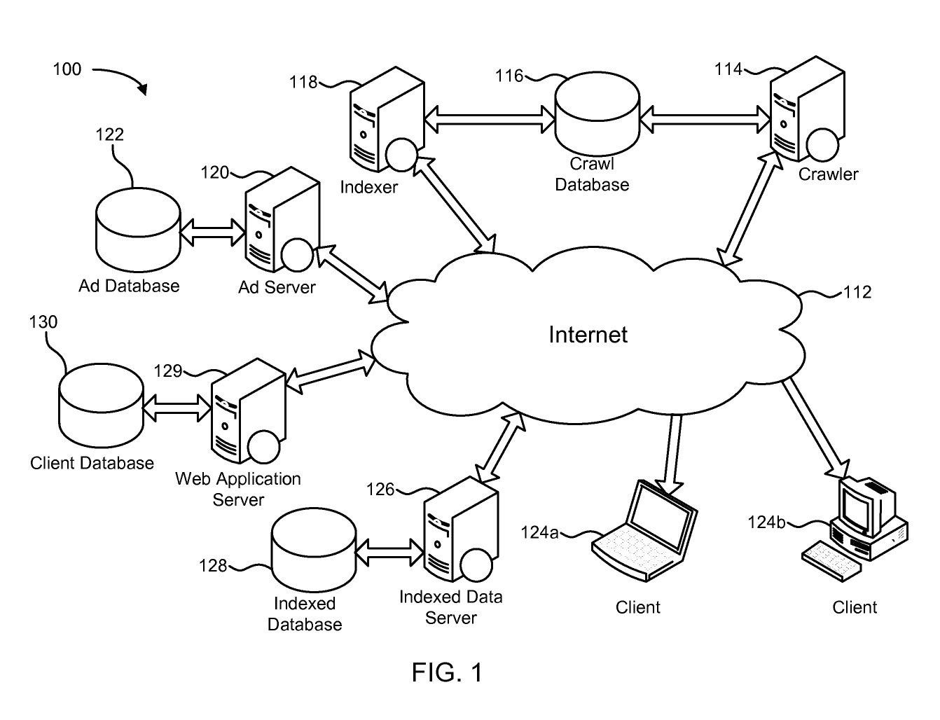

FIG. 1 illustrates one embodiment of an online system 100. The depicted online system 100 uses the internet 112 to facilitate communications among the various components. However, in other embodiments, communications among the many components, or among some of the components, also may occur over one or more networks such as a local area network (LAN), a wide area network (WAN), a wireless network (WiFi), or other types of conventional networks. Alternatively, one or more components within the online system 100 may be coupled directly to another component of the online system 100.

The illustrated online system 100 includes a crawler 114, a crawl database 116, and an indexer 118. In one embodiment, the crawler 114 searches the internet 112 for one or more types of content. For example, the crawler 114 may search the internet 112 for static websites and for dynamic websites, which include dynamic content such as real simple syndication (RSS) feeds. In one embodiment, the crawler 114 is implemented using a third party server (or server farm).

Copies of the content may be stored or cached on the crawl database 116. For convenience, the data objects (e.g., websites, news items, etc.) in the crawl database 116 may be referred to as content objects. One example of a crawler 114 is offered by Alexa Internet of San Francisco, Calif. (www.alexa.com). A brief tour of Alexa's operations is available at http://websearch.alexa.com/static.html?show=webtour/start. In some embodiments, the crawl database 116 may contain a substantial amount of data (e.g., 100 terabytes).

The indexer 118 is coupled to the crawl database 116, in one embodiment via the internet 112, to perform operations on the data stored in the crawl database 116. For example, the indexer 118 may perform feature extraction on the data in the crawl database 116. A more detailed explanation of feature extraction is provided below in reference to the client. Additionally, the indexer 118 may perform other operations to manipulate the data on the crawl database 116. The indexer 118, after feature extraction, may pre-process the data with various forms of scaling. For example, the indexer 118 may apply the Term Frequency (TF), Inverse Document Frequency (IDF), or TFIDF (both combined) approaches, or the indexer 118 may eliminate redundant features, or the indexer 118 may eliminate features with less information content. The indexer 118 may then cluster the data and encode it into static modules so that the crawled information can be distributed more efficiently to users. Some of the scaling and elimination functions may also be applied after clustering. These operations may be performed independently to each domain, such as news, blogs, websites, books, etc.

The depicted online system 110 also includes an ad server 120 and an ad database 122. The ad server 120 and ad database 122 are representative of one or more ad servers and databases, which might be distributed anywhere on the internet 112. In one embodiment, the ad server 120 pulls ads from the ad database 122 and sends them to be displayed on a web browser at a client 124 (either 124a or 124b). Although conventional advertising methods are known, the ad server 120 and ad database 122 also may be used to facilitate improved advertising methods at the client 124 according to a user's advertisement profile, described in more detail below. In one embodiment, though, the client 124 may run software which accesses the ad server 120 in real time. In this way, the client 124 may pull and display the ads to the user. When the user selects an ad at the client 124, the software may redirect the client browser through the ad server 120 so that, under predetermined business arrangements, the ad server 120 and another party may get credits or payment for the user's advertisement selection.

In one embodiment, the online system 100 also includes a web application server 129. In this embodiment, all functions that execute on the client back-end (e.g., all functions other than the user interface (UI) functions) execute on the Web Application Server 129 for all the clients 124. The data for each client 124 used in the back-end functions reside in the client database 130 coupled to the web application server. In some embodiments, the client 124 only executes user interface functions, very much like a standard web application.

The online system 100 also includes an indexed data server 126. In one embodiment, the indexed data server 126 is coupled to an indexed database 128. The indexed database 128 stores object vectors and summary vectors associated with the content objects stored on the crawl database 116. Although the object vectors and summary vectors are described in more detail below, with reference to the client 124, it should be noted that the object vectors are vector representations of the content objects (e.g., websites, news items, etc.) on the crawl database 116, and the summary vectors are vector representations of a group of object vectors. In this way, the indexed data server 126 may access a hierarchy of object vectors and summary vectors (including higher level summary vectors to describe lower level summary vectors). In other words, the indexed data server 126 serves the static data (e.g., vectors) in the indexed database 128. In other embodiments, the data on the indexed database 128 may be distributed around the internet 112 as static files and served by multiple indexed data servers 126. For example, some or all of the data in the indexed database 128 may be cached at the client 124. In one embodiment, companies like Akamai of Cambridge, Mass., and BitTorrent of San Francisco, Calif., may facilitate distribution of the indexed database 128 and indexed data servers 126. The indexed database 128 is divided into static modules of encoded information and distributed to the databases of companies like Akamai or BitTorrent. The users can access these static modules as necessary from these distributed databases.

The online system 100 also includes one or more clients 124a and 124b (individually or collectively referred to as the client 124). Each client 124 represents a user computer or other user access device that is capable of running a web browser. Although many different web browsers may be used, some typical web browsers include INTERNET EXPLORER® by Microsoft and FIREFOX® by Mozilla. Exemplary clients 124 include personal computers, laptop computers, personal digital assistants (PDAs), cellular telephones, and other internet access devices.

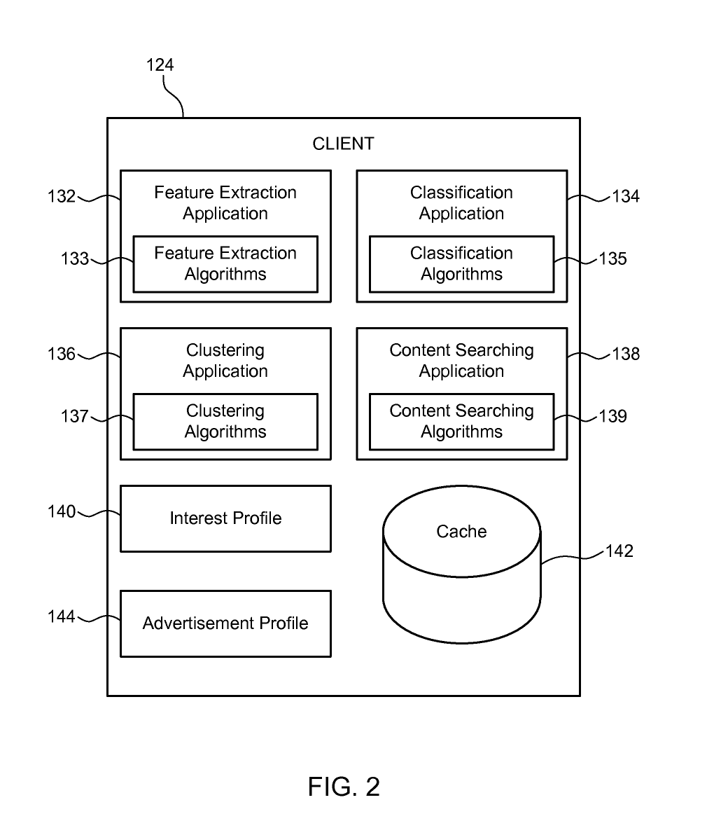

FIG. 2 illustrates one embodiment of a client 124 of the online system 100 of FIG. 1. In general, the client 124 runs one or more client applications which facilitate accessing web content that is correlated to a user's interests. Additionally, the web content may be classified according to the user's disinterests, e.g., topics or content in which the user does not explicitly or implicitly have an interest. In some embodiments, the client application(s) may facilitate additional functionality. Furthermore, although the description below describes separate applications for various functions, the same or similar functionality may be embodied in a single application which runs on the client 124.

In one embodiment, the client 124 includes a feature extraction application 132. In some embodiments, the indexer 118 also may perform feature extraction. The feature extraction application 132 implements a method for modeling a content object by a vector of numbers. The method may include implementing one or more feature extraction algorithms 133. Once a content object is represented by a vector of numbers, classification algorithms can be applied to these vectors, as described below. This feature extraction is based on extracting a core set of features from a content object to adequately model that content object. For example, the features of a piece of text can be a set of unique words in that text, and the vector that models the text can be the frequency of each of the words in that text. In this example, the vector may represent a superset of known words, with the frequency of each word stored in the vector at the locations corresponding to the words used in the text. Although the vector could include, for example, a million numbers corresponding to a million different known words, only the numbers of the vector which correspond to the words used in the text would be non-zero numbers; all other numbers would be zero. As an example, one simplified vector may look like [0 0 0 0 0 0.1 0 0 0 0 0 0.8 0 0 0 0 0.3 0 0 0 0], wherein the non-zero elements are associated with some content or feature of a content object. In some embodiments, the vectors are relatively larger and may have millions of entries (many of which might be zero).

Together with the identification of the relative content, an extract can be identified that can best describe this item to the user. The identification of the extract can be made based on multiple features including, but not limited to, the length of the extract, proximity to the title, etc. This extract can be used as an extended description of the item in the user interface. In addition, a photograph that represents the item can also be identified. The identification of the photograph that best describes the item can be made based on multiple features including, but not limited to, the size of the photograph, proximity to the title, location within the relative content region, and other features that determine if the photograph is or is not related to an advertisement. This photograph can also be used in the user interface to describe the item to the user.

In one embodiment, the feature abstraction application 132 focuses on modeling content objects with meta information and possibly hyperlinks within the content object. As one example, the feature abstraction application 132 uses the meta functions (e.g., titles, subtitles, tables, figure captions, etc.) within the content object and models each of these meta function items as separate features. Using meta functions in this manner may significantly enhance the information content of the model.

As another example, the feature abstraction application 132 may use any hyperlinks within a content object in order to increase the information content of the model. In one embodiment, the feature abstraction application 132 follows the hyperlinks and determines if the content indicated by each of the hyperlinks is fundamentally relevant to the object. If it is relevant, then the model may incorporate the content of the hyperlink into the original content object. This method may be applied to all the hyperlinks in an object. Moreover, this method may be applied to hyperlinks contained in the content associated with the original hyperlinks, and so forth.

The feature extraction application 132 also may identify one or more parts of a content object that has the relevant content. There are multiple ways to do this. In one method, a graphical template approach is used to identify an area of a content object which has relevant information. This template subsequently may be automatically applied to other similar content objects (e.g., different pages of a website).

In another method, an info gain metric may be associated with each feature of the content object. In one embodiment, identified features with negligible info gain for the content object may be eliminated or downgraded. For example, common words such as “a” and “the” may be disregarded when they appear frequently in a given content object. In some embodiments, a similar info gain metric may be applied to several content objects of similar type. This has the effect of enhancing the features with the most information for a class of objects.

In another method, common features within similar content objects may be identified and eliminated or downgrade. This also may have the effect of enhancing those features with the most information for a class of objects.

In another method, objects in a given class are compared to one another and a “structural difference” operation is performed on its content. In other words, structural commonalities in different content objects (e.g., common menu button locations in websites) may be identified and eliminated or downgraded. This also may have the effect of enhancing those features with the most information for a class of objects, assuming the most unique features have the most useful information.

In another method, content of an object may be reconfigured to identify relevant information. For example, formatting commands in a file may be represented by an appropriate number of spaces for each type of formatting command. Then this string of characters (i.e., letters, numbers, and spaces) may be processed to identify contiguous blocks of content. In one embodiment, a contiguous block of content is delineated by a long enough string of spaces, based on the contiguous number of characters preceding it. The usefulness of contiguous blocks of content may be identified by their length after such reformatting.

In one embodiment, the client 124 includes a classification application 134. The classification application 134 implements a method for classifying large amounts of objects. The method may include implementing one or more classification algorithms 135. In one embodiment, the method is based on clustering the objects and summarizing each of these clusters by a “summary vector.” Summary vectors may be similar to object vectors, but summary vectors may be denser than object vectors because they are weighted sums of object vectors. The summary vectors may be used in the classification to determine if a cluster has relevant vectors that should be used in the next level of classification. In some embodiments, a hierarchical approach can be constructed that scales for multiple levels by implementing clusters of summary vectors.

Further, the negative and positive labeled elements of the training set can be modified at each level of the hierarchy to achieve better results. For example, certain negatively labeled elements may be dropped at higher levels of the hierarchy based on the granularity of that level. In another embodiment, certain positively and negatively labeled elements of the training set can be “combined” into one or more negatively and/or positively labeled training set elements based on a given level of the hierarchy.

In order to represent clusters with summary vectors, various embodiments may be implemented. In one embodiment, boundary nodes may be used to represent a collection of vectors by characterizing the boundary between a cluster and other clusters. In this approach, a cluster may be represented by a single summary vector. Alternatively, a series of vectors may be constructed so that each vector characterizes the relationship with one other cluster. In another embodiment, all vectors that have a neighborhood relationship with another cluster can be used to characterize the boundary of a cluster. In a further embodiment, these neighborhood vectors can themselves be summarized into a preset number of vectors.

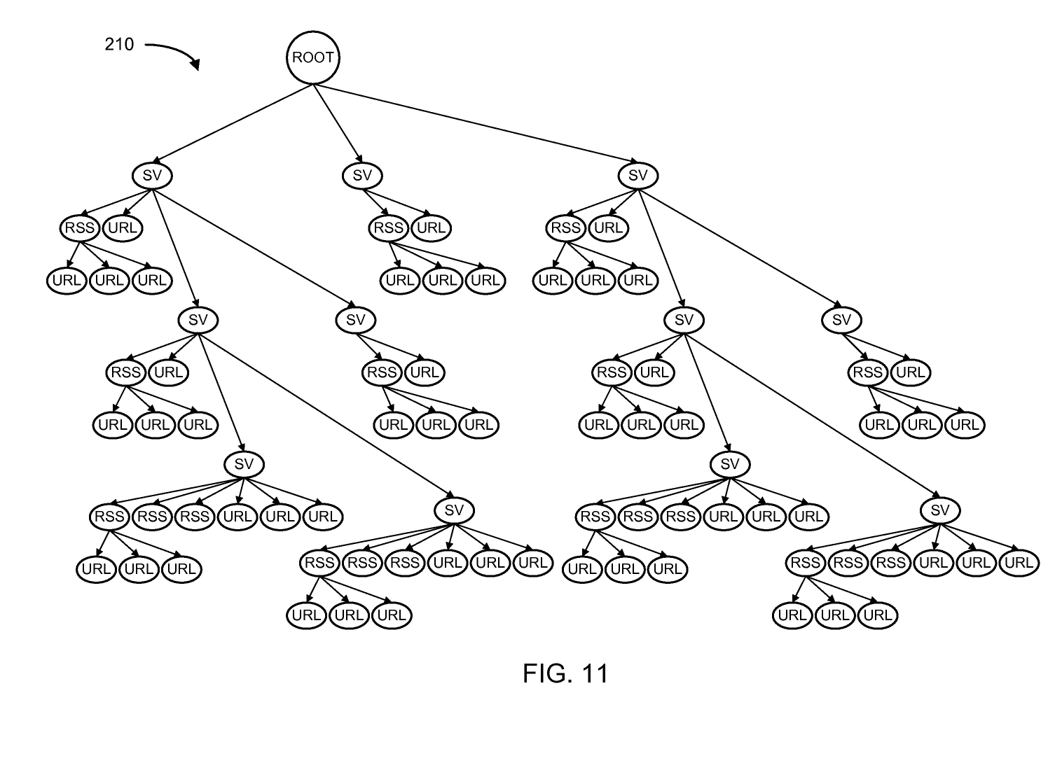

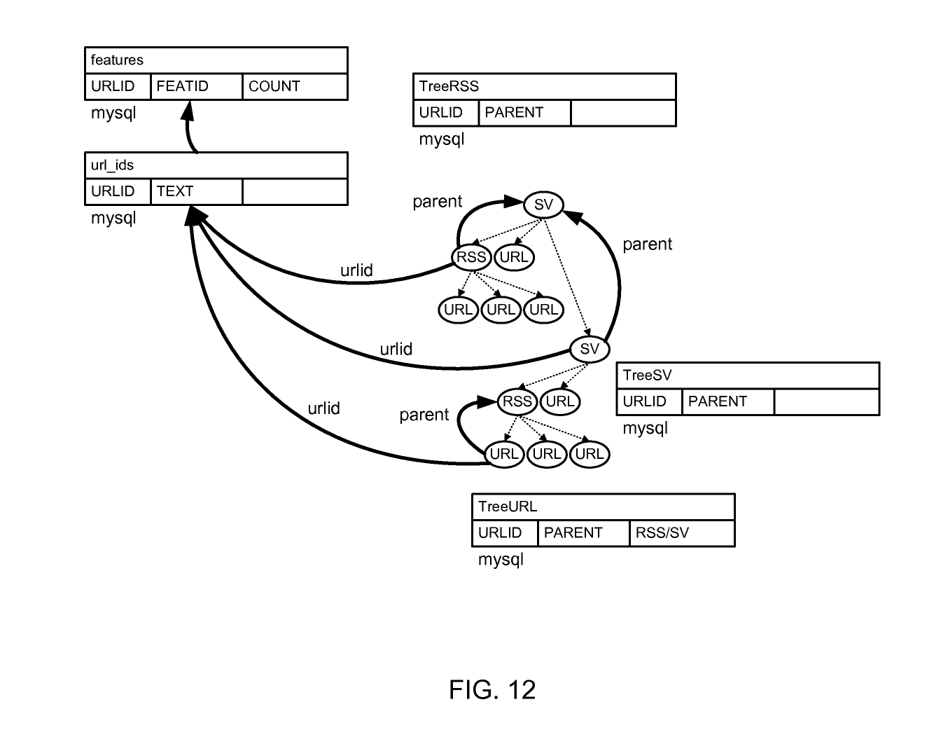

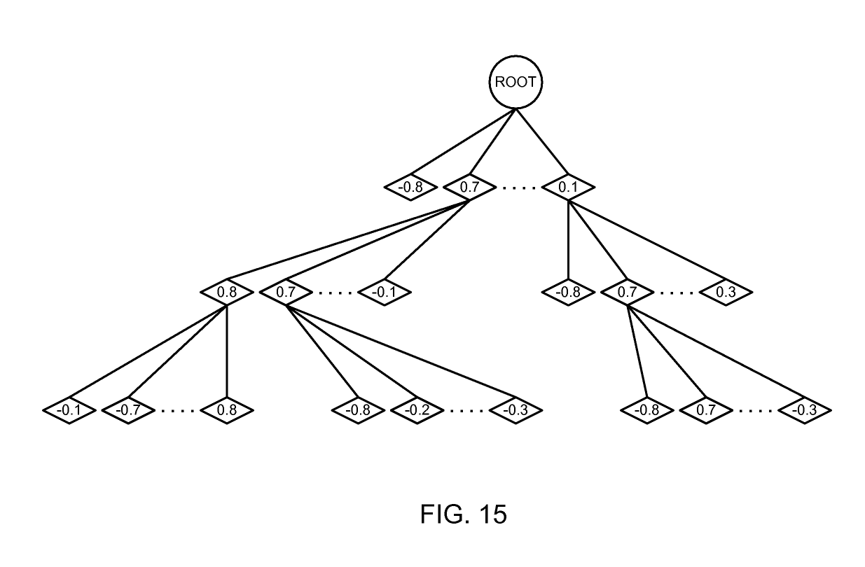

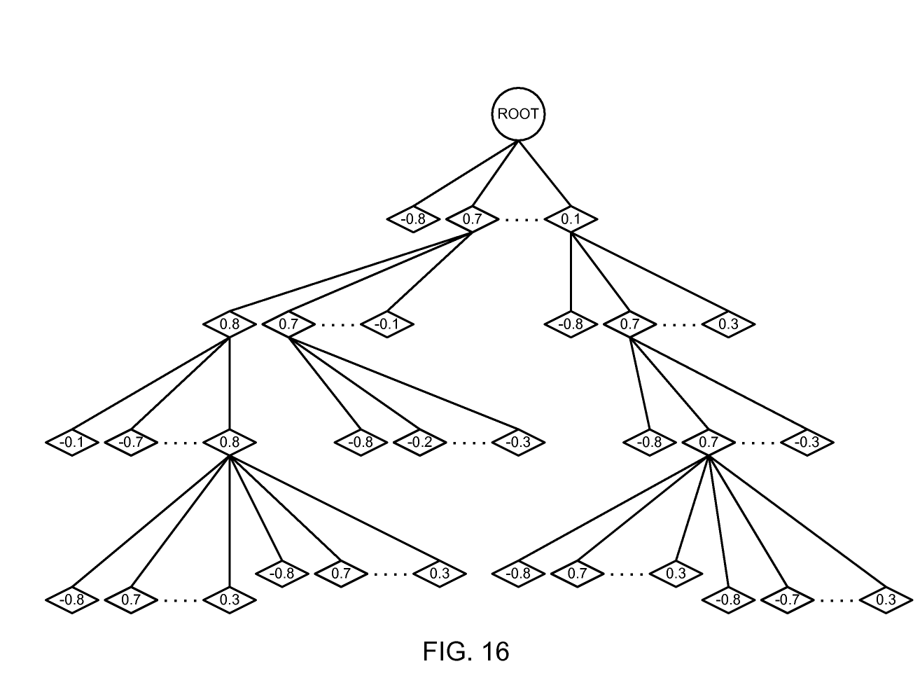

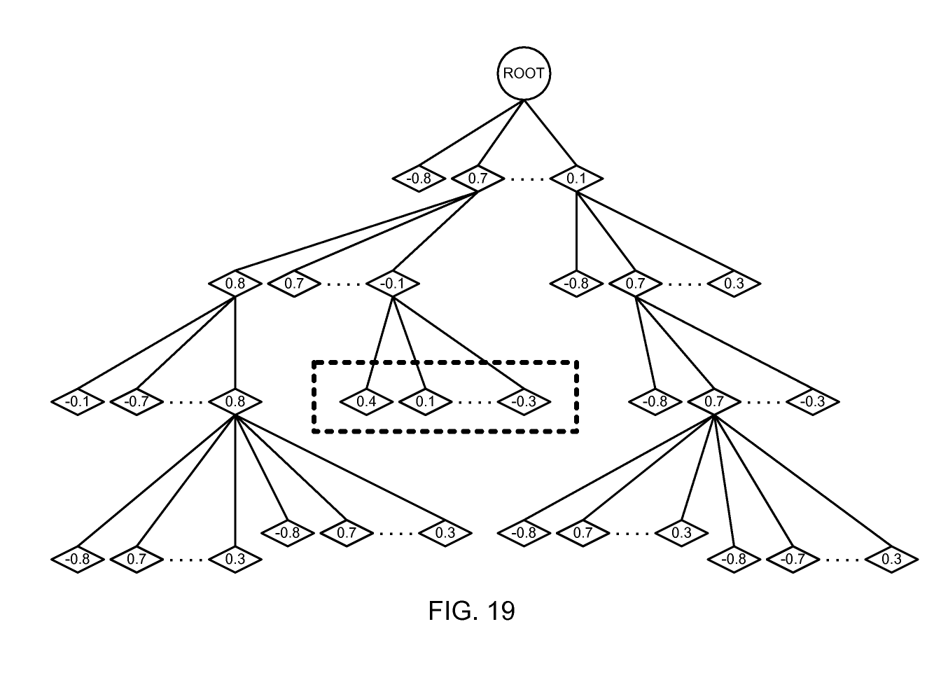

In general, there are two approaches to create a hierarchical classification of vectors. One approach is designated as the “adaptive graph” method. The other approach is designated as the “rapid fire” method. In the “adaptive graph” method of hierarchical classification, a classification graph is constructed by representing clusters at each level either by using the summary vectors of that cluster or the elements of that cluster. At each iteration, summary vectors for relevant clusters are “blown up,” or replaced by its elements. In other words, the summary vector is replaced by the elements associated with the summary vector. In one embodiment, a classification algorithm is used to determine which clusters should be blown up. The result of the adaptive graph classification is the set of elements of the graph that are already at the leaves of the hierarchy. One example of the adaptive graph method is shown in more detail in FIGS. 11-19.

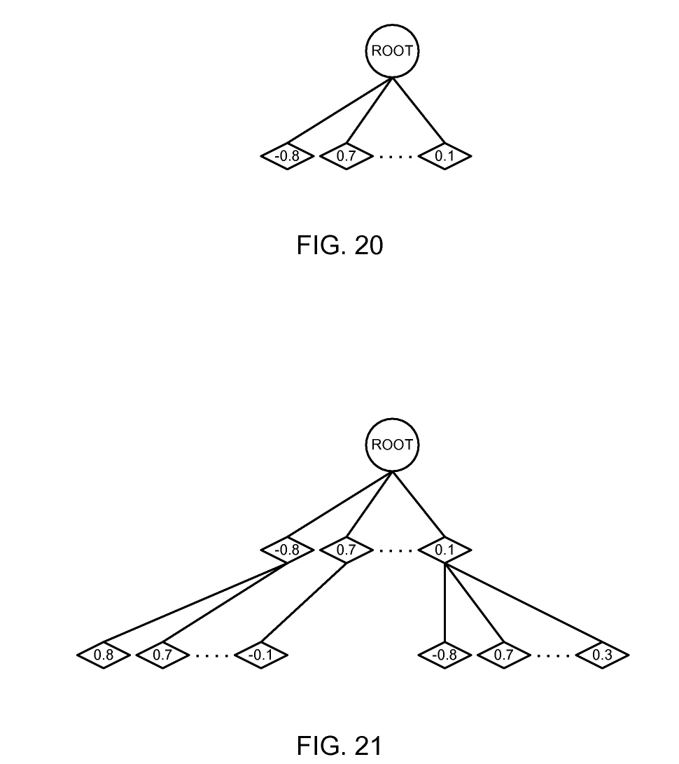

In the “rapid fire” method, a separate classification step is explicitly constructed for each level of the hierarchy. In one embodiment, the first classification is performed using the training set and the summary vectors at the first level of the hierarchy. Then, based on the result of the classification, a subset of the first level clusters is blown up, and, together with the training set, a second level of classification is performed. This iteration is repeated until the leaf level of the hierarchy is reached. One example of the rapid fire method is shown in more detail in FIGS. 20-23.

Further, as described above, the negative and positive labeled elements of the training set can be modified at each level of the hierarchy to achieve better results. For example, certain negatively labeled elements may be dropped at higher levels of the hierarchy based on the granularity of that level. In another embodiment, certain positively and negatively labeled elements of the training set can be “combined” into one or more negatively and/or positively labeled training set elements based on a given level of the hierarchy.

Clustering also may be used to facilitate classification of the vectors, as described above. In one embodiment, the client 124 includes a clustering application 136. The clustering application 136 implements a method for clustering the vectors into high-level groups. For example, a set of 1,000,000 vectors may be subdivided into ten clusters. The method may include implementing one or more clustering algorithms 137. Although there may be many ways to cluster vectors, two approaches include using k-means and graph-based clustering. The approach that is implemented to perform clustering may depend on the number of elements in the set to be clustered. For example, k-means clustering may be used for a set having 1,000,000 vectors. Alternatively, graph-based clustering may be used for a set having, for example, 10,000 vectors or less. In one embodiment, graph-based clustering may provide better results, but is typically limited in the number of objects it can deal with. Alternatively, other approaches may be used.

As an example, the clustering application 136 may cluster 1,000,000 objects into ten groups. In some embodiment, the groups may or may not be equal in size. Then, each group is represented with one or more summary vectors, as described above. Each of these 10 groups is then divided into, for example, another 10 groups. This division process can continue in a similar fashion either for a pre-defined set of levels or until there are a sufficiently small number of elements at the leaf groups.

In some embodiments, hierarchical classification also may be implemented for RSS feeds or other dynamic content. News feeds and weblogs (blogs) are examples of dynamic content. One difference between RSS feeds and many website applications is that the websites are typically static, whereas the content of the RSS changes dynamically. Therefore, for dynamic content such as RSS feeds, the classification application 134 may implement a different method to classify dynamic content. For example, each RSS feed in the domain may be represented statically by taking a snapshot of its contents at some point in time. Typical feature extraction may be performed on the static snapshot of the dynamic content. Next, the hierarchical classification approach may be used to select a group of RSS feeds that the user might be interested in for a particular tag. Selected RSS feeds may be added to any RSS feeds that the user may have configured manually for the same tag. Next, the current items in each RSS feed may be sampled and classified with positive and negative examples which the user has provided in order to pick the set of RSS items that the user is likely to be interested in. As new items show up in these RSS feeds, the item level classification may be repeated. Alternatively, the item level classification may be repeated on a regular basis. Additionally, the hierarchical RSS feed classification may be repeated when the user provides new input in the form of positive or negative tagging.

In one embodiment, the classification application 134 also may implement a method for optimizing the parameters used to classify the vectors. First, a random training set is selected based on clusters. For a given training set, the optimum parameters are found for a level in the hierarchy based on achieving the maximum percentage of truly positive elements surviving in the hierarchy nodes selected as a result of the classification. This optimization step may be repeated for each level of the hierarchy. When the leaf level is reached, the optimum parameters are found based on achieving one or more of the following: a maximum percentage of truly positive elements within those that are classified as positive; a weighted sum of scores for the positive elements at the leaf level; or the number of truly positive elements within a pre-determined number of highest ranked elements. Alternatively, other criteria may be used. The optimum parameters are then applied to a series of tests, each of which uses a different random training set. In one embodiment, the test is measured by statistics on the accuracy of the top diverse elements that are selected.

In one embodiment, the client 124 also includes a content searching application 138. The content searching application 138 implements a method for searching for content that is similar to a user's interest profile 140. In one embodiment, the content searching application 138 uses the classified and clustered vectors to determine which objects should be associated with the user's interests and which objects should not be associated with the user's interests. Additionally, the content searching application 138 may determine which objects might be associated with the user's disinterests. The method may include implementing one or more content searching algorithms 139. In some embodiments, the method may implement a Bayesian algorithm, a support vector machine (SVM) algorithm, or a spectral graph theory (SGT) algorithm. Each of these algorithms is described below, although the general details of these algorithms are known within the context of conventional applications. Alternatively, the method may implement another algorithm.

The Bayesian algorithm is a conventional statistical approach. Basically, it considers the weighted average for a positive example (e.g., known interests) and a negative example set (e.g., known disinterests). Using this information, the content searching application 138 may determine whether a candidate object should be labeled as an interest or a disinterest (or simply not labeled as an interest) based on the candidate object's relative distance from the two weighted averages.

The SVM algorithm is a conventional algorithm to determine a boundary between the positive set and the negative set. In order to identify the boundary, the SVM algorithm takes into account known positive and negative examples, and finds the “maximally separating” boundary between the two sets. In other words, it finds the boundary that has the maximum width.

The SGT algorithm is a conventional algorithm that is somewhat similar to the SVM algorithm. The SGT algorithm operates on a graph that represents all the objects in the domain, including positive and negative objects, as well as candidate objects. It reduces the boundary identification to a minimum cut problem on the graph.

In order to facilitate content searching, the client 124 may store at least a partial copy of the data from the indexed database 138 on a local cache 142. In one embodiment, the cache 142 stores data that is likely to be related to the user's interests defined in the interest profile 140. In this way, the client 124 may primarily search the local cache 142, saving time and power by not having to communicate with the indexed data server 126 or other system components for every content search. The client cache 142 may be updated, for example, periodically or in response to an update to the user's interest profile 140.

In one embodiment, the interest profile 140 is a vector of numbers to indicate which objects a user has indicated are interests and which objects the user has indicated are disinterests. In one embodiment, the user may “tag” or mark a content object (or the associated vector) as an interest or disinterest by marking the content via a user interface such as an internet browser. For example, after the content searching application 138 returns some content objects that the user might be interested in, the user may tag one or more of the returned content objects as an interest by selecting an icon next to a representation (e.g., a hyperlink or a summary description) of the content object. In one embodiment, the icons for the user to select interests and disinterests may be “thumbs up” and “thumbs down” icons, respectively, although other types of icons, graphics, text, or colors may be used instead or in addition to these exemplary icons.

In one embodiment, the client 124 also may store an advertisement profile 144. The advertisement profile 144, similar to the interest profile 142, may be a vector of numbers to indicate which advertisements the user does or does not like. In some embodiments, the advertisement profile 144 may depend at least in part on the interest profile 142. In some embodiments, the advertisement profile 144 or the interest profile 142, or both, may be used to select advertisements to be presented to the user. For example, advertisement keywords may be computed in real time, based on the “dynamic” interest profile 140, and sent to the ad server 120, which returns relevant ads (or a subset of ads) to be displayed to the user.

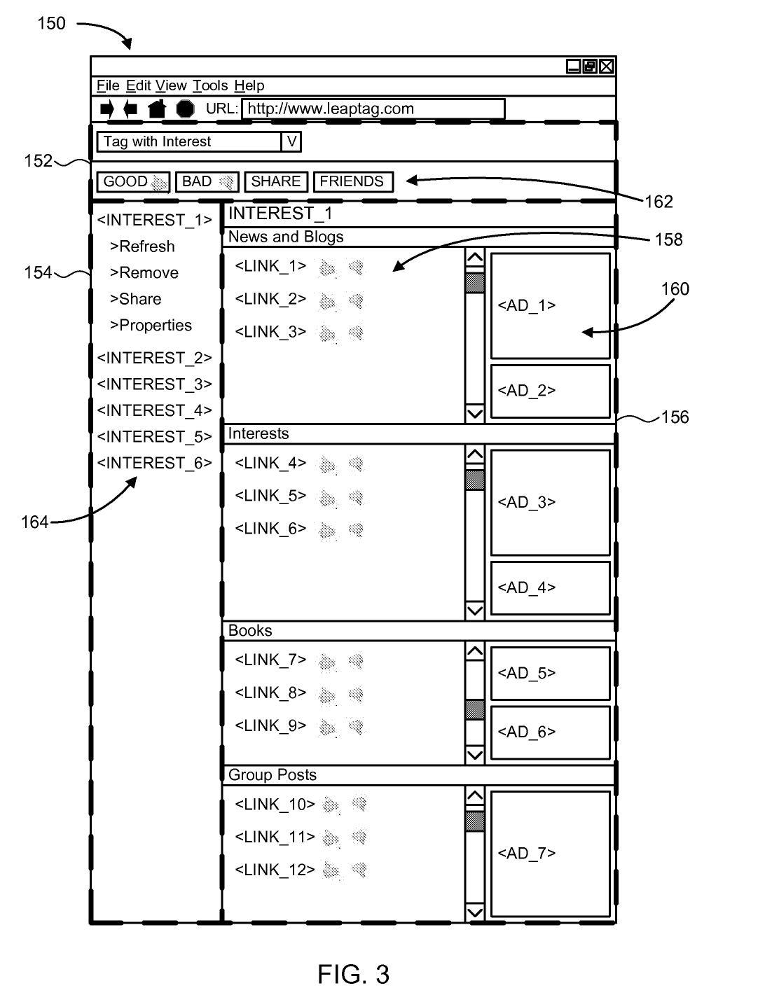

FIG. 3 illustrates one embodiment of a web browser 150 with a user interface for the online system 100 of FIG. 1. Although a particular web browser 150 is shown in the drawing, other embodiments may be implemented in conjunction with other types of web browsers. The illustrated user interface implemented in the web browser 150 includes a toolbar 152, a sidebar 154, and a main window 156.

In one embodiment, the main window 156 displays content from the internet 112. This content may be retrieved from the internet 112 according to the interests and disinterests of the user (which may be displayed in the sidebar 154, for example). As described above, the interests and disinterests of the user may be defined in the interest profile 150 stored on the client 124. In one example, the main window 156 may display internet links 158 to several categories of internet content, including “News and Blogs,” “Interests,” “Books,” and “Group Posts” (shown in FIG. 3). Advertisements 160 also may be displayed (for example, along the right edge of the main window 156). Additionally, the main window 156 may include excerpts from the linked websites, dates, times, pictures, and other similar content information. In one embodiment, the main window 156 also includes icons 162 (or other selection mechanisms) to allow a user to indicate whether or not they are interested in the displayed link or content. This selection may be stored in the user's interest profile 140. For example, the user may designate a link to a national tennis tournament as an interest, but designate a link to a table tennis website as a disinterest.

In one embodiment, the interest profile 140 is hierarchical in that it allows the user to designate content that the user considers interesting or not interesting as it relates to a particular theme. Using the previous example, the user may select a table tennis link as a disinterest as it relates to the theme, or interest, of tennis. However, the user also may designate the same table tennis link as an interest as it relates to another theme, or interest, such as ping pong. In this way, the same content may be designated as selectively belonging to one interest, or theme, and not to others for the same user.

In one embodiment, the sidebar displays a list of the user's designated interests. For each interest, the user may select a tab 164, and the contents of the sidebar 154 may be adjusted to show a summary of links 158 or other information related to the selected interest. In another embodiment, the sidebar 154 also may show designated disinterests. Additionally, the sidebar 154 may display an icon or use another indicator to indicate which interests are shared with other users.

In one embodiment, the toolbar 152 may include several buttons 162 or other user interface devices to allow the to navigate the user interface, designate content as an interest or disinterest, share interests with other users, search for content related to a selected interest, and so forth.

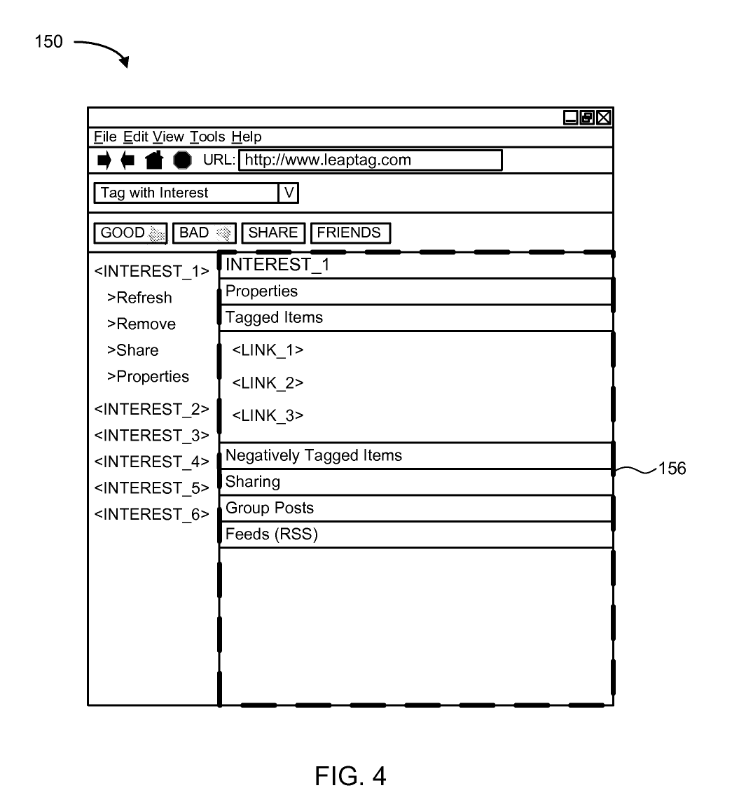

FIG. 4 illustrates another embodiment of the web browser 150 and user interface of FIG. 2. In the depicted embodiment, the user interface allows a user to see and navigate properties of each of the selected interests. For example, a user may see and modify which content objects (e.g., websites, links, RSS feeds, etc.) the user has designated as belonging to that interest theme. Also, the user may see and modify which content objects the user has specifically excluded as disinterests (i.e., negatively tagged) from the selected interest theme. The depicted user interface also may allow the user to modify sharing properties for the interest, view and modify group posts related to the interest, and so forth.

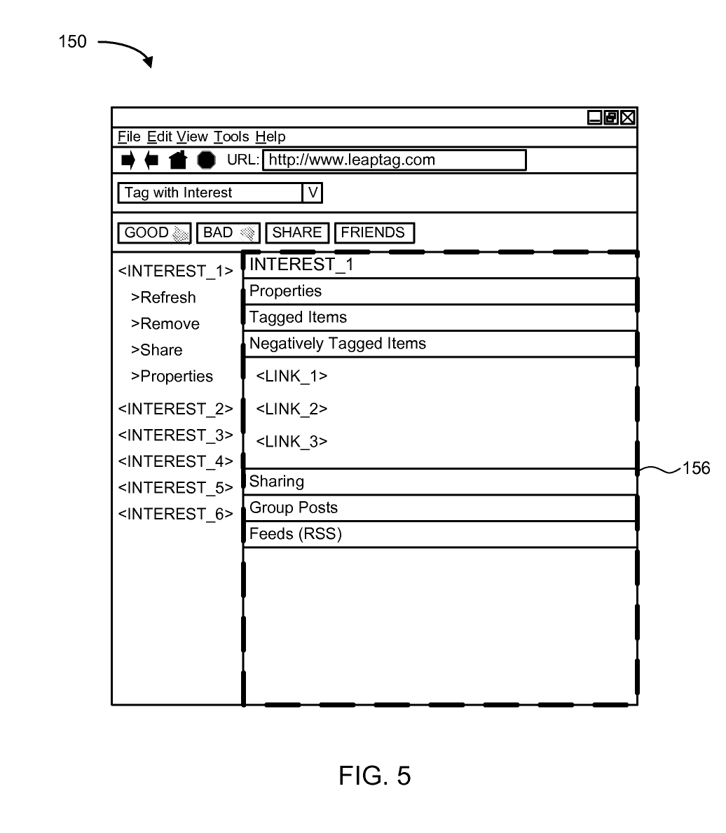

FIG. 5 illustrates another embodiment of the web browser 150 and user interface of FIG. 2. In particular, FIG. 5 shows an exemplary list of negatively tagged content objects. In this instance, the user has selected these items as being disinterests as they relate to the selected interest theme.

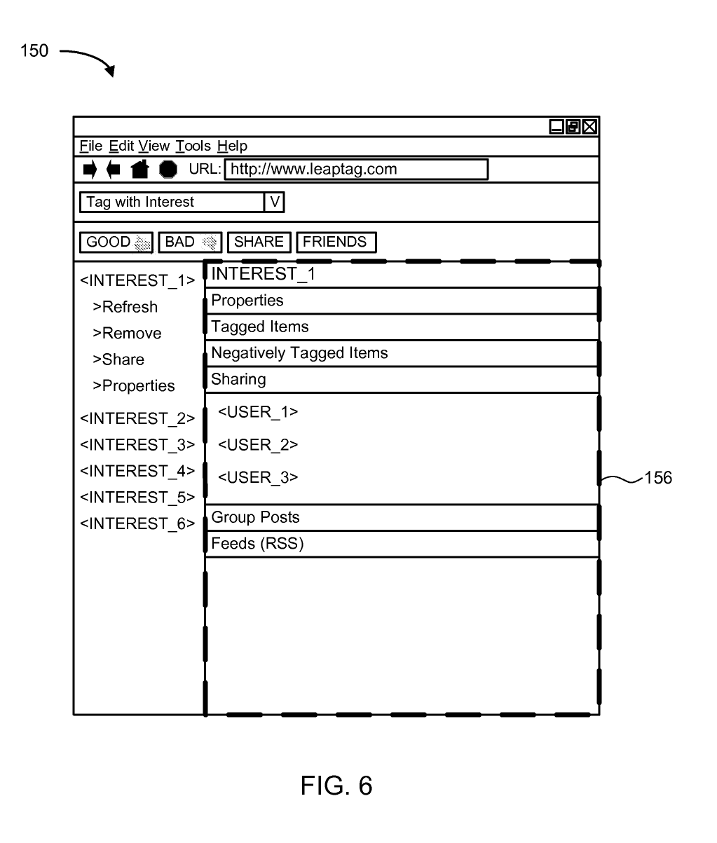

FIG. 6 illustrates another embodiment of the web browser 150 and user interface of FIG. 2. In particular, FIG. 6 shows an exemplary list of potential users with whom the user may share an interest. For example, the user may invite other users to share a selected interest, thereby allowing the invited users to so and potentially modify the user's selected interest profile.

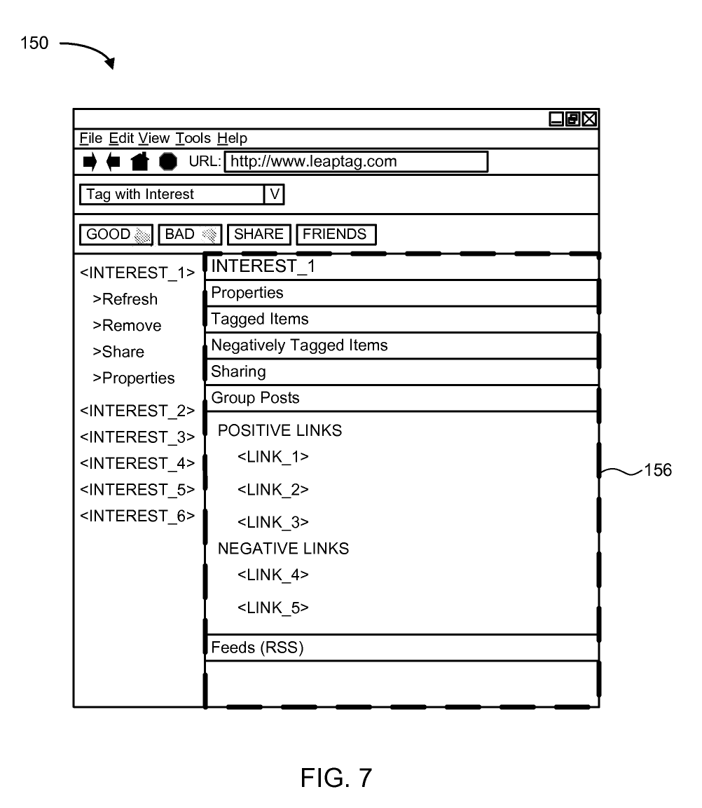

FIG. 7 illustrates another embodiment of the web browser 150 and user interface of FIG. 2. In the case where a user shares an interest with other users, the user interface may allow the user to see the groups combined positively and negatively tagged content objects of the group. In this way, the user may see which other users have tagged a particular content object.

In other embodiments, the user interface may allow the user to perform other functions in regard to creating and managing the user's interest profile, as well as finding new content objects that might relate to the user's selected interests. In one instance, the user may provide high level preferences as they relate to their interests which can then be used in conjunction with and to drive the classification results. In another instance, the user may group his interests to higher level interest groups, which the application could use to organize content. For example, if the user groups his interests into “Arts”, “Business”, “Politics”, etc., then for example the News view can be organized to display, essentially, a personalized newspaper, with “Arts”, “Business”, etc., sections.

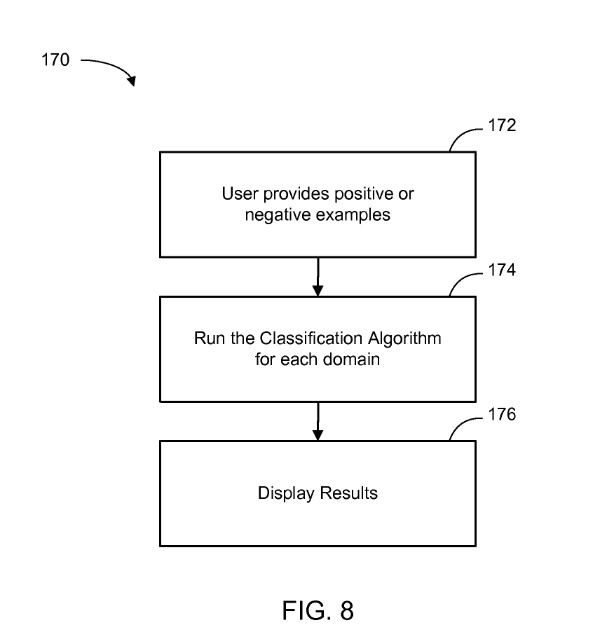

FIG. 8 illustrates a schematic flow chart diagram of one embodiment of a content classification algorithm 170. In one embodiment, the content classification algorithm 170 may be implemented by the classification application 134, as described above. In the depicted embodiment, the user provides 172 positive or negative examples such as the designations from a user interest profile 140. The classification application 134 then runs 174 a classification algorithm for each domain, and then may display 176 the results.

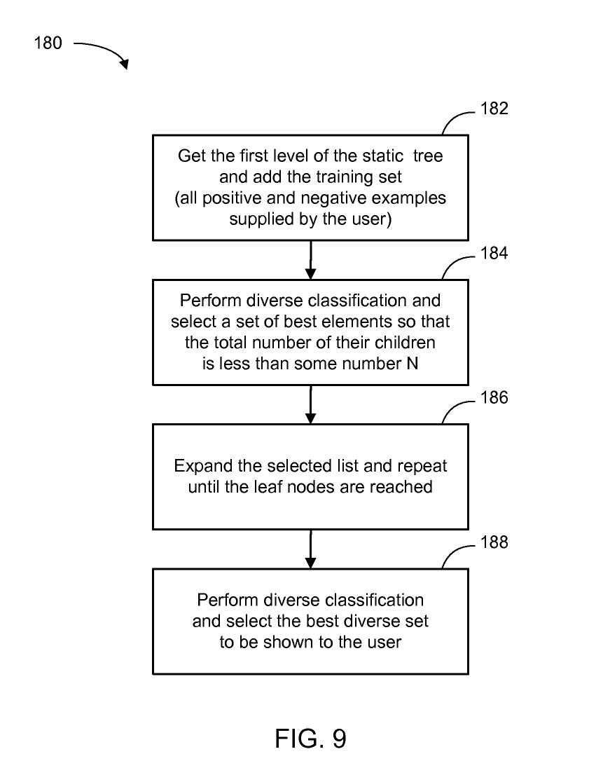

FIG. 9 illustrates a schematic flow chart diagram of another embodiment of a content classification algorithm 180 for classifying a static domain. In the depicted embodiment, the classification application 134 gets 182 the first level of a static tree and adds a training set. An example of a training set is a set of positive and negative examples provided by the user. The classification application 134 then performs 184 diverse classification and selects a set of best elements so that, in one embodiment, the total number of “children” elements is less than some number, N. The classification application 134 then expands 186 the selected list and repeats the previous operations until the leaf nodes are reached. Then, the classification application 134 performs 188 diverse classification and selects the best diverse set which may be shown to the user.

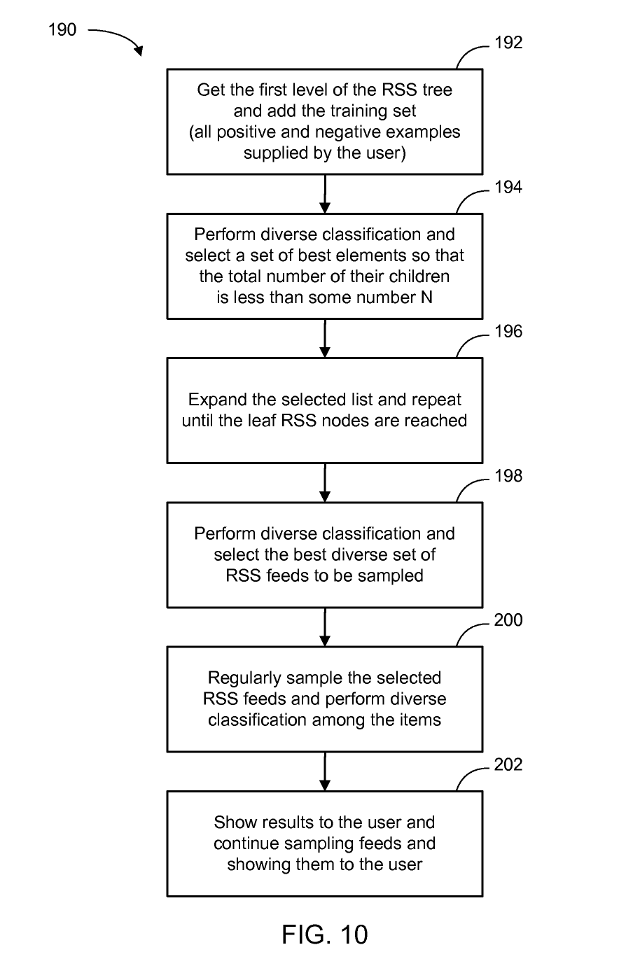

FIG. 10 illustrates a schematic flow chart diagram of another embodiment of a content classification algorithm 190 for classifying a dynamic domain using really simple syndication (RSS) feeds. In the depicted embodiment, the classification application 134 gets 192 the first level of an RSS tree and adds the training set. The classification application 134 then performs 194 diverse classification and selects a set of best elements so that, in one embodiment, the total number of “children” elements is less than some number, N. The classification application 134 then expands 196 the selected list and repeats the previous operations until the leaf RSS nodes are reached. The classification application 134 then performs 198 diverse classification and selects the best diverse set of RSS feeds to be sampled. Using this information, the classification application 134 regularly samples 200 the selected RSS feeds and performs diverse classification among the items. Then, the classification application 134 may show 202 the results to the user and continue sampling feeds in a similar manner.

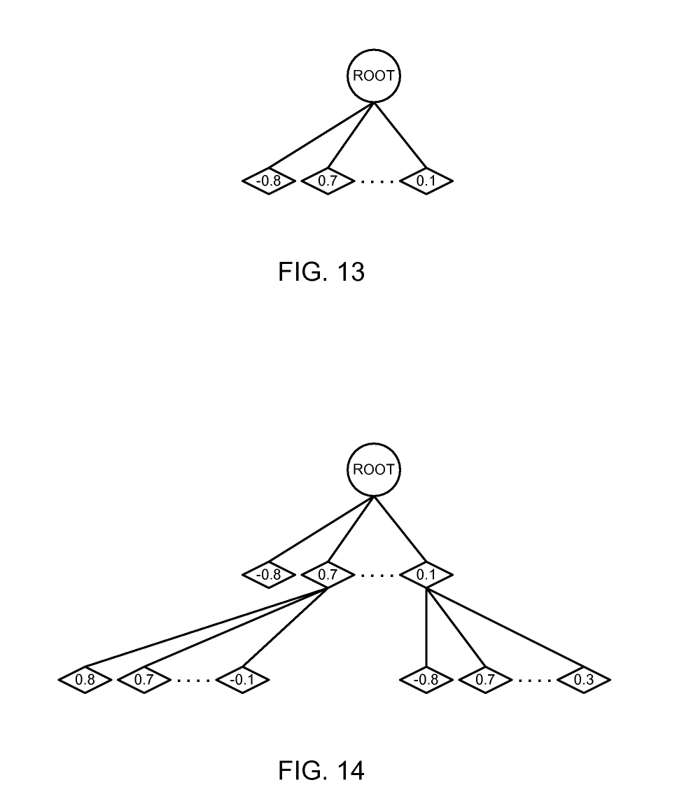

FIGS. 11-23 illustrate embodiments of hierarchical classification algorithms that may be implemented to classify content objects in the online system of FIG. 1. In particular, FIGS. 13-19 illustrate one embodiment of the adaptive graph method 210, and FIGS. 20-23 illustrate one embodiment of the rapid fire method 220, both of which are described above.

For the adaptive graph method 210, the indexed data server 126 has a representation of the results of hierarchical classification. At each node, the indexed data server 126 has a summary vector (SV). Also, the indexed data server 126 maintains the closest URL for that summary vector. In some embodiments, this URL is not repeated further below in the tree. The indexed data server 126 also maintains the closest RSS for each node. At the leaf level, the indexed data server 126 maintains URLs and RSSs. In some embodiments, this representation in the indexed data server 126 changes periodically (e.g., monthly).

The client 124 instantiates several classifiers (one per user/tag pair). For each classifier, the client 124 develops a relevant and resource-constrained mirror of the server-side tree. In some embodiments, a classifier is relevant if it contains a URL that the user is interested in. Similarly, a classifier may be relevant if it contains summary vectors that allow a good classification for classification of new RSS items and/or ads. In some embodiments, a classifier is resource-constrained if it is not possible to replicate the entire server side tree onto the client 124.

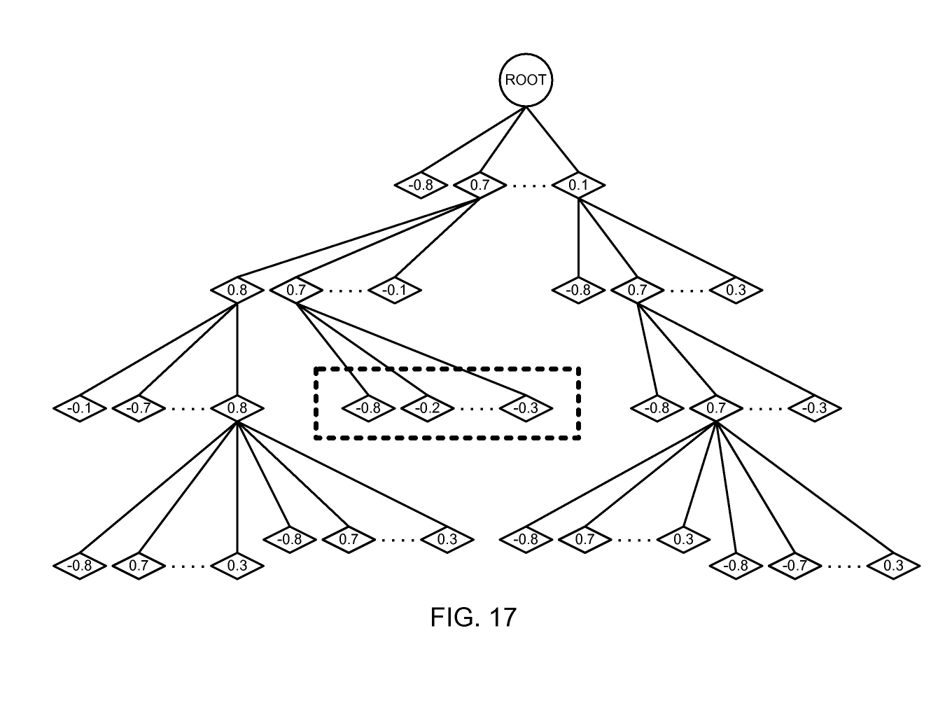

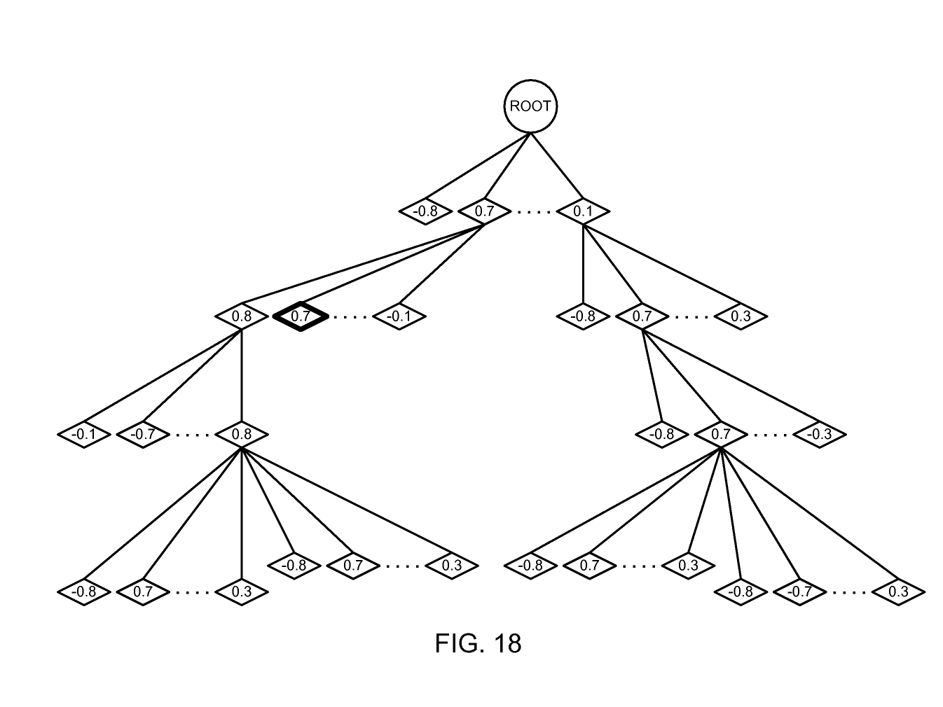

In one embodiment, the adaptive graph method 210 begins by blowing up the root. For example, URLs and/or RSSs may be presented to the user for tagging. Additionally, some nodes may be blown up. For example, positively scored nodes may be blown up. Also, nodes with the highest score may be blown up. This process continues until constrains are violated or until the leaves of the URLs and RSSs are reached. In the meantime, there may be families of nodes that may be removed from the tree (see FIGS. 17 and 18) to improve the results. If maximum constraints are reached for the number of nodes in the tree, then families of nodes that pull down the results (e.g., negative averages) may be removed. In some embodiments, this is performed without affecting the current status of the other nodes. When no other positively scored nodes can be blown up, then the nodes with the most positive scores can be blown up. Other embodiments of the adaptive graph method 210 may include additional features.

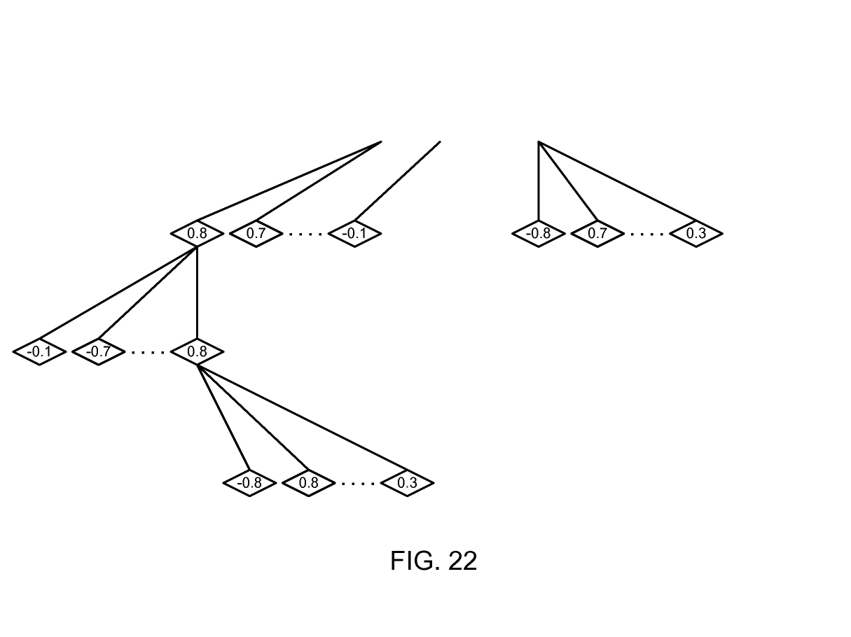

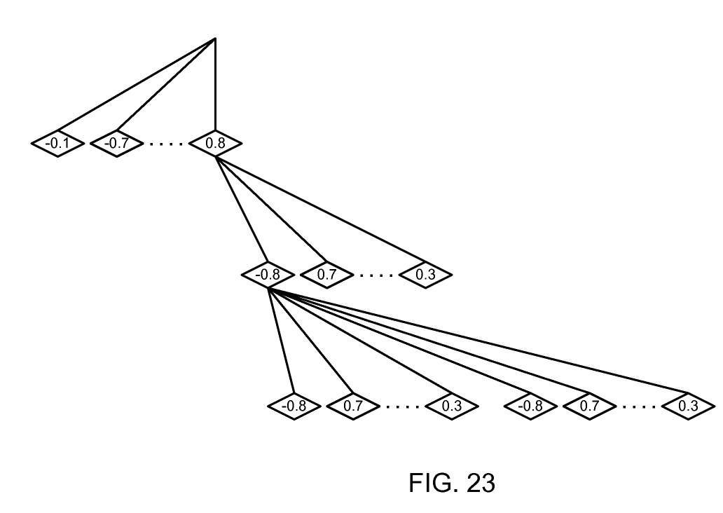

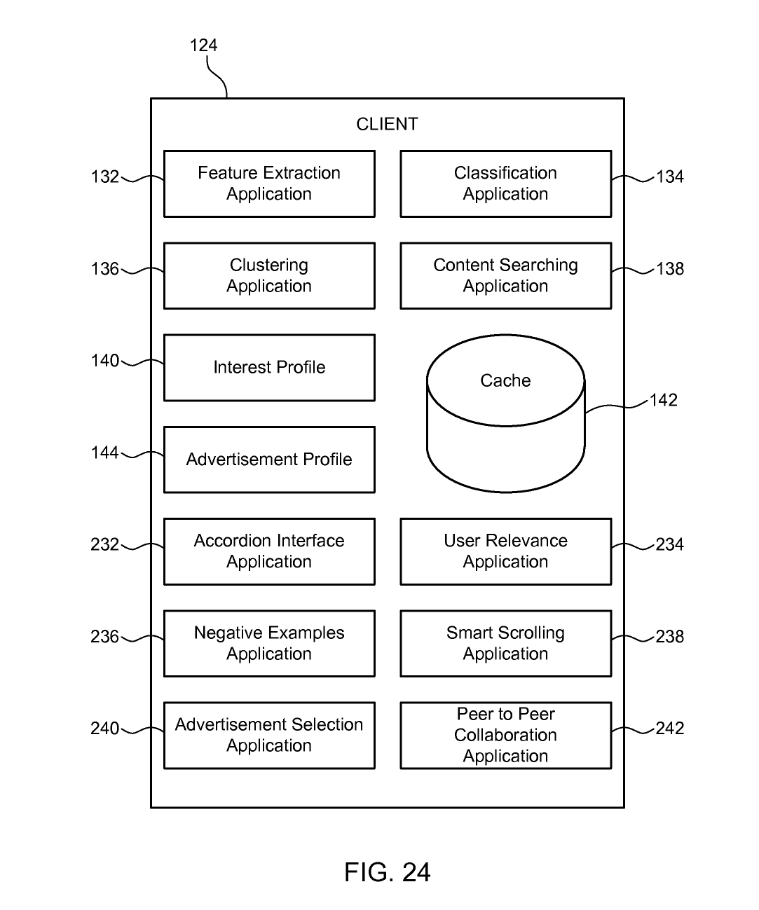

For the rapid fire method 220, the root is blown up, similar to the description above. URLs and/or RSSs are also presented to the user for tagging. As the best nodes are blown up, some of the levels of the hierarchy may be discarded (see FIGS. 22 and 23). Some of the operations of the rapid fire method 220 may be substantially similar to the operations of the adaptive graph method 210. Other embodiments of the rapid fire method 220 may include additional features.

ADDITIONAL EMBODIMENTS. It should be noted that many of the embodiments described herein may incorporate additional functionality such as the functional described below. FIG. 24 illustrates another embodiment of the client 124 of FIG. 2, including additional applications to facilitate implementation of some or all of the functions described below. For example, the depicted client 124 also includes an accordion interface application 232, a user relevance application 234, a negative examples application 236, a smart scrolling application 238, an advertisement selection application 240, and a peer to peer collaboration application 242. Other embodiments of the client 124 may include fewer or more applications.

DIVERSE SUGGESTIONS AND LEARNING. One embodiment implements a method to increase classification accuracy as well as suggestion diversity using a very small set of learning examples. The learning examples are shown to the user to allow the user to identify which ones are interests and which was are disinterests. In one embodiment, the domain is classified and clustered. When choosing the suggestions for the set of learning examples, the cluster information may be used in addition to score information, which results from clustering. In this way, the method may facilitate showing a diverse set of possible selections to the user, while limiting the number of similar possible selections. For example, only a single content object is shown from a group of similar content objects (e.g., news items) from different sources (e.g., news agencies), no matter how strongly relevant they might be to the user's selected interest. Instead, different possible selections of content objects (e.g., news items) that are relevant to the user's interests may be shown. Additionally, since the user's feedback is based on the suggestions, the algorithm receives diverse feedback. This may beneficially speed up the convergence of the classification algorithm.

ADVERTISEMENT SELECTION. One embodiment implements a method for displaying relevant advertisements while the user is surfing the web. In one embodiment, the possible advertisement content is classified based on user interests. In one method, all the potential advertisements are downloaded and feature extraction is performed. The domains of advertisements may be classified together with other domains, and the top relevant advertisements are shown to the user. In another method, a domain of keywords may be used. For each keyword, a web search is performed, and feature extraction is performed on the results that are returned. The domain of keywords may be classified together with other domains. The top keywords are used and sent to the advertisement feed (e.g., advertisement server) to receive advertisement content relevant to those keywords. In another method, also using a domain of keywords, an advertisement domain search is performed for each keyword, and feature extraction is performed on the results that are returned. The domain of keywords may be classified together with other domains. In one embodiment, the top keywords are sent to the advertisement feed to receive advertisements relevant to those keywords.

In some embodiments, the advertising selection methods may allow the user to provide positive or negative feedback on the advertisement. This feedback is then used to select targeted advertisements that match the user's advertisement profile. In another embodiment, similar functionality may be applied to conventional online auction content that is content based rather than keyword based.

PEER TO PEER LEARNING AND CLASSIFICATION. One embodiment implements a method of collaborating on web surfing and communicating results between different users. In this method, a user may share an interest among a set of peers chosen by the user. The positive and negative feedback supplied by any peer within this group is then applied to the classifiers of all other peers within the group as positive and negative examples, respectively. However, the classifications for each peer within the group may be performed independently. In this way, the users potentially may be shown different results resulting from the different classifications. Their feedback is collected and the process is repeated with the new feedback. In one embodiment, when an item is tagged positively or negatively by any member of the group, the member can attach a note to the item which will then be transmitted to all the other group members. In response, another member can positively or negatively re-tag the same item, attaching a different note. In this way, the users can converse about the shared interest through items they tag and the attached notes. In another exemplary embodiment, a commercial company can sponsor a large group. This large group may have moderators which can tag items negatively or positively for the group, and spectators who can only view the results. In one embodiment, this implementation may be used by a company to promote their products.

In order to implement this peer to peer collaboration, an application program interface (API) to exchange data may be used. For example, many internet chat programs have an application to application API which allows users to use its chat capabilities for exchanging data. In one embodiment, SKYPE® may be used as the internet chat program. Alternatively, other chat programs may be used. Skype is a chat and voice program available from Skype Technologies of London, United Kingdom. In particular, Skype has an application to application API which allows its chat capabilities to be used for exchanging data to implement the sharing functionality. In one embodiment, Skype's user naming mechanism may be used to uniquely identify users across the internet. In this way, the user naming and the chat mechanism may allow one user (local user) to invite another user (target user) to share a tag, or interest. For example, in one embodiment, a target member may be polled to determine if the target member has installed application the peer to peer collaboration application. If not, the local user may invite the target user to install the application. After verifying that the target user has installed the application, the target user may be notified about the local user's invitation to share a tag, or interest. Next, whenever the local user selects a document to be tagged, some or all of the shared users may be notified about this tagging action. Additionally, the local user may attach a note to this notification. Similarly, whenever any user selects a document to be tagged, some or all member users are notified. In one embodiment, this notification is performed reliably (i.e., even if a member user is not present, that user is eventually notified when they become available). In this way, even two users who are never online at the same time may be able to communicate in this fashion and share interests provided that there are some users who share the same tag and who are online at the same time with them (i.e., in one embodiment, there may be a sequence of members of the same tag whose internet use overlaps in time). The same mechanism may be used to terminate the membership in the tag by any party.

DISCOVERING ONE TYPE OF RELEVANT CONTENT USING FEEDBACK FROM A COMPLETELY DIFFERENT TYPE OF CONTENT. One embodiment implements a method for content discovery which uses training examples for one type of content (or domain) to discover a completely different type of content (or domain). In one embodiment, training examples are provided for one type of content such as internet websites. The classification algorithm, described above, may be capable of finding relevant content from, for example, news articles using examples provided from the internet sites domain. This is possible at least in part because each domain has its own feature extraction. By using a unique feature extraction for each domain, fundamental pieces of information may be extracted from a content object and used to model an object from each domain. Therefore, feedback received for objects in a particular domain can be used to discover content in a completely different domain.

This method may have business applications. For example, this method may be implemented in business models supported by advertising. In one approach, feedback provided by the user in the news domain and the websites domain may be used to extract keywords relevant to the user. These keywords are then used to extract keyword based advertisement from ad servers. In one embodiment, the extracted advertisements are relevant to the user's interest. Under conventional business models, when a user clicks on an advertisement, revenue is generated.

In another approach, the feedback may be used to classify a books domain, allowing potential book selections that are relevant to the user's interest to be shown to the user. Under conventional business models, when the user makes a purchase, revenue is generated. In another approach, the feedback may be used to classify an auctions domain, allowing auction items that are relevant to the user's interest to be shown to the user. When the user makes a purchase from the auction site, revenue is generated.

TEMPLATES. One embodiment implements a template. In one embodiment, a template is an interest tagged with a pre-defined set of positive and negative examples. Templates may be used in various ways. For example, templates may be prepared for typical interests such as international politics, sailing, football, and so forth. In one embodiment, a library of templates may be created and distributed to a user as a service. In another embodiment, partner organizations may request that specific templates be prepared for them for their use or for their clients. The preparation of templates may be provided as a service for organizations. Additionally, users may be allowed to create templates or template groups and distribute these to other users.

ACCORDION INTERFACE. Another embodiment implements an “accordion” user interface mechanism. In one embodiment, the accordion user interface mechanism may be used both in the sidebar 154 and the main page 156. Each accordion user interface mechanism may include the following properties: the contents can be anything; restrictions can be imposed on their behavior (for example, when one item is opened, all other items can be forced to close); they can be reordered by conventional drag and drop operations; and they remember their state so that when a page is revisited, the open/close state for each individual pane is preserved.

USER RELEVANCE DURING BROWSING. One embodiment implements a method for inferring a user preference of a particular URL by observing the user's browsing habits. In this method, user sessions are identified in which the user is looking for a particular piece of information or a particular category of information. Such sessions may be delineated by the gaps in user activity with the browser. In each session, the user's preference may be inferred by the length of time a user spends at a particular page or how the user navigates away from the page. For example, a preference to designate a page as a user interest may increase with as the user's “dwell” time and interaction with a page increases. As another example, a preference to designate a page as a user interest may decrease if the user navigates away from the page by using a typical “back” page operation in the browser.

CREATING NEGATIVE EXAMPLES WHEN THERE ARE NONE. One embodiment implements a method for creating negative examples when the user has supplied no negative examples. For example, if the user has only positive examples, then the method may create negative examples to facilitate improved classification. In this method, a number of examples from clusters that are farthest away from the positive examples may be selected as the negative examples. In another embodiment, a number of examples from the positive examples related to other interests of the user may be selected so that examples from overlapping interests can be determined and avoided by using a distance metric between examples for the interest in question and the other interests. In another embodiment, negative examples which the user may have specified for any other interest may be used, with the exception of those examples which are similar to the positive examples for the selected interest, as determined by a distance metric.

SMART SCROLLING OF LISTS. One embodiment implements a method for scrolling lists in an infinite “tape loop” fashion. This method involves an infinite slider, in addition to tape player style play, stop, and fast forward buttons. The user can access any location in this potentially infinite list by moving the slider, and the list changes “on demand” based on the user requests. In addition, the user can instigate scrolling of this list by hitting the play button in the appropriate direction. Hitting the stop button stops the scrolling and hitting the fast forward button increases the scrolling speed.

Embodiments of the present invention include various operations, which are described herein. These operations may be performed by hardware components, software, firmware, or a combination thereof. As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; electrical, optical, acoustical, or other form of propagated signal (e.g., carrier waves, infrared signals, digital signals, etc.); or another type of medium suitable for storing electronic instructions.

Additionally, some embodiments may be practiced in distributed computing environments where the machine-readable medium is stored on and/or executed by more than one computer system. In addition, the information transferred between computer systems may either be pulled or pushed across the communication medium connecting the computer systems.

The digital processing device(s) described herein may include one or more general-purpose processing devices such as a microprocessor or central processing unit, a controller, or the like. Alternatively, the digital processing device may include one or more special-purpose processing devices such as a digital signal processor (DSP), an application specific integrated circuit (ASIC), a field programmable gate array (FPGA), or the like. In an alternative embodiment, for example, the digital processing device may be a network processor having multiple processors including a core unit and multiple microengines. Additionally, the digital processing device may include any combination of general-purpose processing device(s) and special-purpose processing device(s).

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A system for advertisement selection, the system comprising:
a client capable of accessing content objects over the internet;
an advertisement selection application coupled to the client, the advertisement selection application to maintain at least a partial copy of advertisements;
wherein the advertisement selection application is further configured to classify the advertisements and to generate an object vector for each advertisement; and
wherein the advertisement selection application is further configured to update a user interest profile in response to positive and negative feedback, and to display advertisements according to the user interest profile.

2. The system of claim 1, wherein the object vector comprises a vector of numbers representative of a frequency of a superset of features potentially found in the content object.

3. The system of claim 1, wherein the user interest profile comprises a vector of numbers that identify the likes and dislikes of a user.

4. The system of claim 1, wherein the advertisement selection application further classifies advertisements according to a domain of keywords capable of being classified with a second domain of keywords.

5. The system of claim 1, further comprising an advertisement server to maintain the advertisements.

6. A computer program product comprising a computer useable storage medium to store a computer readable program that, when executed on a computer, causes the computer to perform operations for advertisement selection, the operations comprising:
access content objects over the internet;
maintain at least a partial copy of advertisements;
classify the advertisements and generate an object vector for each advertisement; and
update a user interest profile in response to positive and negative feedback, and display advertisements according to the user interest profile.

7. The computer program product of claim 6, wherein the object vector comprises a vector of numbers representative of a frequency of a superset of features potentially found in the content object.

8. The computer program product of claim 6, wherein the user interest profile comprises a vector of numbers that identify the likes and dislikes of a user.

9. The computer program product of claim 8, wherein the computer readable program, when executed on the computer, causes the computer to perform an operation to classify advertisements according to a domain of keywords capable of being classified with a second domain of keywords.

10. The computer program product of claim 6, wherein the computer readable program, when executed on the computer, causes the computer to perform an operation to maintain the advertisements.

11. A method for advertisement selection, the method comprising:
accessing content objects over the internet;
maintaining at least a partial copy of advertisements;
classifying the advertisements and generating an object vector for each advertisement; and
updating a user interest profile in response to positive and negative feedback, and displaying advertisements according to the user interest profile.

12. The method of claim 11, wherein the object vector comprises a vector of numbers representative of a frequency of a superset of features potentially found in the content object.

13. The method of claim 11, wherein the user interest profile comprises a vector of numbers that identify the likes and dislikes of a user.

14. The method of claim 11, further comprising classifying advertisements according to a domain of keywords capable of being classified with a second domain of keywords.

15. The method of claim 11, further comprising maintaining the advertisements.
